(19) United States
(12) Patent Application Publication
(10) Pub. No.: US 2010/0043287 A1
(43) Pub. Date: Feb. 25, 2010

(54) TREATMENT APPARATUS FOR PLANT MATTER

(75) Inventors: Christopher Martin Jones, Cambridge (GB); Shane Anthony Slater, Cambridge (GB); Andrew Charles Turton, Ely (GB)

Correspondence Address: SUGHRUE MION, PLLC, 2100 PENNSYLVANIA AVENUE, N.W., SUITE 800, WASHINGTON, DC, 20037, US

(73) Assignee: FOTOFRESH LIMITED, Douglas, Cork (IE)

(21) Appl. No.: 12/516,308

(22) PCT Filed: Nov. 22, 2007
(86) PCT No.: PCT/GB2007/004473

§ 371 Date: Jul. 31, 2009

(30) Foreign Application Priority Data
Nov. 27, 2006 (GB) 0623636.8

(51) Int. Cl. A01G 7/00

(52) U.S. Cl. 47/1.1 R

(57) ABSTRACT

Treatment apparatus (10) comprises red-light emitting means (15) and blue-light emitting means (16), in particular diodes, for emitting red light and blue light, respectively, and directing the emitted light into a target zone (14) for irradiation of plant matter (13) when disposed in the zone. The diodes (15, 16) are operable to provide a substantially homogenous blend of the emitted red and blue light in the target zone for at least a major part of the period of emission and to emit the light at wavelengths of 625 to 660 nanometres for the red light and 440 to 470 nanometres for the blue light with intensities in the target zone of up to 500 microEinsteins for the red light and up to 400 microEinsteins for the blue light. The apparatus includes a control unit (21) to control the diodes (15, 16) to provide a predetermined relationship of the intensity of at least one of the emitted red light and emitted blue light to the period of emission of that light so as to ensure that the irradiation is sufficient to achieve the result of stimulating, in the irradiated plant matter, a phytochemical response enhancing nutritional value, storage life or other characteristics.

The present invention relates to treatment apparatus and has particular reference to treatment of plant matter whether, whole plants (growing or non-growing) or any material derived from a plant, including leaves, stalks, roots, fruits and berries. The invention further relates to equipment provided with apparatus of that kind.

It is known to irradiate plant material, especially growing plants and harvested plants including edible produce, with various forms of light from both the visible and the invisible spectrum to stimulate selective reactions in the plant cells and tissue. Treatment of this kind can, depending on the light employed, the wavelength and other parameters of the irradiation process, serve to stimulate growth, modify appearance, increase the levels of desired constituents such as essential oils and aromatic components, and other purposes. More recently it has been determined that irradiation with specific categories of light with selected wavelengths and intensities can enhance nutritional values of, inter alia, harvested plant materials, particularly vegetables and fruits, and combat surface deterioration leading to early wastage. Treatment apparatus for irradiation of this kind has generally taken the form of an ad hoc construction and arrangement of elements necessary for achieving the desired result in a particular situation, in many instances in quasi-experimental or laboratory situations as distinct from an industrial, commercial or domestic context. Irradiation of plant matter under the specific conditions essential to consistently achieve the intended result requires an apparatus construction able to ensure that the treatment can be carried out repeatedly in the desired manner and, if appropriate, with a capability of adaptation to accommodate different forms of plant matter, different objectives of the treatment and different environments. Conveniently usable apparatus meeting these criteria have not been available hitherto.

It is therefore the primary object of the present invention to propose a construction of treatment apparatus in which treatment of plant matter can be carried out under controlled conditions in such a way as to ensure consistently reliable results.

A subsidiary object is realisation of an apparatus construction which allows simple operation of its functioning components, preferably automatic operation, and which is appropriate to mass production for industrial, commercial or domestic requirements.

Yet another subsidiary object is provision of a basic apparatus construction which can be scaled up for commercial or industrial application or conversely can be of compact dimensions for domestic use, particularly for incorporation in domestic appliances.

According to the present invention there is provided treatment apparatus comprising red-light emitting means and blue-light emitting means for emitting red light and blue light respectively and directing the emitted light into a target zone for irradiation of plant matter when disposed in the zone, the emitting means being operable to provide a substantially homogenous blend of the emitted red and blue light in the target zone for at least a major part of the period of emission and to emit the red light and blue light at wavelengths of substantially 625 to 660 nanometres and substantially 440 to 470 nanometres respectively and at intensities in the target zone of up to substantially 500 microEinsteins and up to substantially 400 microEinsteins respectively, and control means to control the emitting means to provide a predetermined relationship of the intensity of at least one of the emitted red light and emitted blue light to the period of emission of that light.

Apparatus of this kind provides a defined target zone or treatment area in which plant matter being treated is irradiated with red and blue light in a substantially uniform mixture for all or most of the treatment time. The light of each colour is emitted in a predetermined wavelength and at a predetermined intensity in the target zone, which may be generally regarded as a three-dimensional rather than merely two-dimensional region, to achieve a desired enhancement or modification of the treated material. This may include increase of nutritional value and/or taste, extension of shelf life or storage capacity, elimination or reduction of pathogenic infestation leading to spoilage and other results generally equating with improvement in one or more characteristics of the material. The substantially homogenous blend of the red and blue light, both colours being necessary to achieve these results, ensures that the material is treated effectively and consistently. Critical to attainment of these results in the context of the apparatus is the incorporation of a measure, provided by the control means, to provide a predetermined relationship of the intensity of at least one, but preferably both, of the emitted light colours to the period of emission. The irradiated plant matter is thus exposed to the treatment light for a period of time recognised to be appropriate to the specified intensity. The predetermined relationship may significantly vary depending on the nature of the plant matter concerned, the desired treatment result, the temperature in the target zone and the end use of the treated material, including the immediacy of consumption in the case of edible produce.

Depending on the respective treatment parameters the control means can be operated to cause the periods of red light and blue light emission to terminate substantially simultaneously, which may be the usual procedure, or at predetermined or predeterminable different times. In certain circumstances a greater period of irradiation of the plant matter with light of one or the other colour may be appropriate and in that case treatment with light of the relevant colour can be extended for a specific time either automatically or by user intervention.

In its simplest form the control means can comprise switching means manually operable to terminate the period of red or blue light emission, the period being dependent on the respective intensity and thus requiring monitoring by the user. Preferably, however, this task is performed by timing means operable to terminate the emission period after a time predetermined or predeterminable in dependence on the intensity of the respective light. Thus, depending on the intensity, timing means can be set to switch off the red and/or blue light emitting means at a point when it is recognised that the elapsed treatment time will have been sufficient for the desired result. Whether or not the period of emission is under the control of timing means, it can be advantageous for the control means to include the operating capability of varying the period of emission of the emitted red light or blue light in dependence on the intensity of that light and additionally or alternatively a capability of varying the intensity of the light of either colour in dependence on the respective period of emission. Dynamic adaptation of the irradiation of the plant matter by increasing or decreasing the emission intensity or increasing or decreasing the emission period can thus be carried out if circumstances require, particularly to accommodate losses in intensity due to ageing of light sources of the emitting means, atmospheric or temperature change in the target zone, partial failure of one of the light emitting means, and other variables which may or may not be predictable. Such a dynamic control can, as indicated, be structured to provide compensation for long-term and short-term influences on the treatment parameters. Variation of intensity of the emitted red or blue light by the control means can be conveniently carried out by, for example, varying a drive power of the associated emitting means.

In the case of, in particular, a variable control function realised on an automatic basis the apparatus preferably comprises sensing means arranged to detect the intensity of the emitted red light or blue light in the target zone and to cause at least one of the intensity of that light and the period of emission of that light to be varied as a function of the detected intensity. Provision of sensing means to exert an automatic control function of the kind described allows self-regulated or feedback operation of the apparatus to achieve optimum results on the basis of certain fixed presets, including, at least, the relationship of light intensity to duration of emission. In this connection, the sensing means preferably comprises a respective sensor responsive to the wavelength of each of the emitted red light and the emitted blue light to detect the intensity of the light only of that wavelength and to supply a signal indicative of the detected intensity to the control means. Thus, sensors individually responsive to the wavelength ranges of the red and blue light can be provided, in or adjacent to the target zone, to report the intensity of the respectively associated light colour substantially without falsification of the detection result by the intensity of the other light colour, notwithstanding the homogenous light blend in the target zone. A basis for selective control of the intensity or emission period of either one or both of the light colours is thus realised.

It may also be important for the control means to have an operating capability of controlling the periods of red light and blue light emission, the intensities of the emitted red and blue light or both the periods and the intensities in dependence on the temperature in the control zone. If, for example, the target zone is located in a refrigerating environment, such as in a compartment of a domestic refrigerator typically with a temperature of 0 to 8° C., more usually 2 to 6° C., within a range of about −0.5 to +10° C., it is desirable to provide red light and blue light intensities in the ranges 10 to 30 and 5 to 20 microEinsteins respectively, preferably 10 to 25 and 5 to 15 microEinsteins respectively, and exposure periods of up to about 4 hours. Alternatively, if the target zone is represented by a cooled area, for example display shelving typically having a temperature of about 4 to 18° C., red and blue light intensities of 10 to 50 and 5 to 25 microEinsteins respectively, preferably 10 to 30 and 10 to 20 microEinsteins respectively, but typically 20 to 30 and 15 to 20 microEinsteins respectively, are appropriate in conjunction with emission periods similar to those mentioned for a refrigerating environment. Conversely, in the case of cooking equipment, short-term exposure of, for example, about 45 minutes at room temperature with red and blue light intensities of 100 to 400 and 50 to 250 microEinsteins respectively, preferably 150 to 350 and 100 to 200 microEinsteins respectively, may then be appropriate. Irradiation with light at lower intensities may be more favourable in the case of cooled storage of plant matter, such as in refrigerators and display shelving, so that the build-up of nutrients is gradual and the accumulated nutrients are consumed at a slow rate by plant cells. Irradiation with higher intensities, such as in conjunction with cooking appliances, may produce a faster build-up of the nutrient level and consequently greater rate of consumption of the nutrients; the latter is of lesser significance in view of the probability of use of the treated plant matter shortly after treatment, for example cooking of vegetables for consumption. The control means may control the emission periods, the light intensities or both the periods and the intensities by way of components fixing the apparatus operating capability in a case where the apparatus constructed for one specific temperature environment, manually such as by user selection of switch-on periods for the emitting means, semi-automatically by user input of temperature values to which the control means can react differently, or entirely automatically by use of temperature detecting means to detect the temperature in the target zone and supply a signal indicative of the detected temperature to the control means. The last-mentioned option provides a dynamic control able to provide adjustment for unintentional fluctuations or intentional changes of temperature in an artificially cooled environment containing the target zone.

Similarly, it may be of advantage if the control means is operable to control the periods of red light and blue light emission, the intensity of the emitted red and blue light or both the periods and the intensities in dependence on predetermined characteristics of the plant matter to be treated. Such characteristics can include, inter alia, at least one of the type, size, weight, density, composition, age and life, i.e. growing or non-growing, status of the plant matter. Again this control may be carried out as a function of fixed presetting of the parameters of the treatment carried out by the apparatus or by manual action. Semi-automatically and automatically executed control actions are equally possible, particularly in the case of industrial apparatus. In general, however, variations in plant matter type, size, age, etc., may arise only periodically and thus, for the avoidance of complication, control actions may be initiated manually by, for example, adjustment of timing means determining the light emission periods or adjustment of the drive power of the emitting means.

The emitting means can be operable to emit the red light and blue light continuously, for example in the case of a target zone in a refrigerating environment where continuous exposure for about four hours may be appropriate. Alternatively, the emitting means may be operable discontinuously so that, with respect to the mentioned example, the desired exposure is achieved over a longer period, such as eight hours, with extended periods of time in which there is no irradiation. In the case of discontinuous light emission, this can be carried out at constant frequency, thus with regular intervals of irradiation and non-irradiation. Alternatively, it can be carried out at non-constant frequency, in which case there can be equal periods of emission and non-emission, with the emission duration being different in length from the non-emission duration. By way of arbitrary example, the non-constant frequency may be such as to provide periods of irradiation each of 30 minutes separated by periods of non-irradiation of 15 minutes. Such a relationship may equally well be reversed depending on the particular requirements and the circumstances of use of the treatment apparatus.

In terms of construction as distinct from functional capabilities, the apparatus configuration is preferably such that each of the red-light emitting means and blue-light emitting means comprises a plurality of discrete light sources. A single source for each of the red and blue lights may suffice depending on the volume of the target area, but in general a plurality of sources assists attainment of the required level of intensity over a typical coverage area. The sources of each light emitting means can be connected in series or parallel, but in a typical application with about 12 sources it can be advantageous to, for example, connect the sources partly in series and partly in parallel to ensure voltage and current compatibility with the capabilities of variable-current drivers when such are employed to provide variable light intensity control. A convenient form of source is represented by a light-emitting diode, such diodes being economically available, reliable and comparatively straightforward to control.

The pattern of light emission from each source can be selected as desired, but preferably is substantially conical. In that case, attainment of a uniform mix of the red and blue light in the target zone is assisted if each cone of light of one colour runs into at least one core of light of the other colour in the target zone. The target plant matter is then located in a region bathed in light derived from both the red light sources and blue light sources, even though at a spacing from the target the two colours of light are entirely separate.

For preference, each emitting means comprises optical means for directing, shaping or both directing and shaping the light emitted by the sources, in which case the particular form of light emitted by the sources without optical influence may be of little consequence and it is possible to use sources—which are items not immune from occasional failure—that are inexpensive and simple to replace. Such optical means can advantageously be a respective lens associated with each source, such as a light-collimating element to provide a shaped beam, for example cone of predetermined diameter in a plane in the target zone.

The disposition of the sources can be selected from a wide range of possibilities, but one particularly convenient method is arrangement of the sources of at least one of the light emitting means in at least one row. Arrangement in a row or in rows enables the pattern of light generated by the sources to illuminate a generally elongate area in the target zone, so that compact plant matter can be located anywhere in that area and elongate plant matter can be accommodated without the extremeties escaping irradiation. It has proved advantageous from the aspect of homogenous blending of the light in the target zone to then arrange the red light sources in a first row and the blue light sources in a second row parallel to the first row or, more preferably, to arrange the red light sources and the blue light sources in alternation in two mutually parallel rows. In either case, each red light source may then be located in close proximity to a blue light source so that the requisite light output points are favourably disposed for interference and blending of the output light in the target zone. Blending of the light may be promoted by disposition of the two rows of sources to define two relatively angled light output planes including an obtuse angle. In effect, the light output of one row is oriented towards that of the other so as to meet in or near the target zone, the particular angle of inclination of the light output planes preferably being matched to—possibly even adjustable by reference to—the spacing of the sources from the target zone or the height of the material to be treated.

In order to take into account the possibility of flexible construction of the apparatus to allow adaptation to different requirements and different sizes of target zone while operating within the constraints of mass production it can be advantageous to arrange the sources in a group forming a module or alternatively in a plurality of groups each forming a respective module. As a further advantage it may then be possible to add additional modules of like format to extend the capabilities of the apparatus. Such modules are preferably electrically connected in parallel, such as by way of a power bus, or alternatively in series.

The light emitting means, particularly when formed by light-emitting diodes, may in operation generate a substantial amount of waste heat, which preferably should be dissipated by way of a heat sink incorporated in the apparatus. Further features of the apparatus can include a power supply unit for power supply of the apparatus, which may be essential in the case of light sources such as diodes with operating voltages below mains voltage, and support means in the target zone for supporting material to be treated.

Such support means can be in the form of, for example, a shelf of solid transparent or non-transparent material, a grid or other specialised support appropriate to specific uses. The target zone may itself be enclosed by a suitable enclosure, particularly when the apparatus is constructionally and functionally independent of other equipment. Display means may also be present for displaying data relative to the emitted light intensities, the periods of emitted light or both the intensities and the periods so as to assist user control of the apparatus. Optical and/or acoustic warning means can be included to provide warning of a fault condition or other anomaly.

If the apparatus is intended for, for example, storage of produce or other plant matter in a cold environment the apparatus, insofar as it functions independently of cooling or refrigerating equipment, may comprise cooling means for maintaining the target zone at a temperature of substantially 0 to 10° C., preferably substantially 0 to 5° C.

The apparatus is, however, particularly suitable for inclusion in commercial or household equipment intended for storing, displaying or processing plant matter. Thus, in a further aspect the invention comprises equipment provided with treatment apparatus, as defined in the foregoing, for treating plant matter being cooled or refrigerated by the equipment. The nutritional value and/or storage life of plant matter, such as vegetables and fruits, stored in the equipment under cooling or refrigerating conditions may be able to be enhanced by the treatment apparatus at least while the cells or tissue of the plant matter remains or remain responsive to stimulation by the selective light irradiation. In that case, the apparatus may be fully integrated in the equipment so that the target zone is represented by, for example, a shelf or grill conventionally present in the equipment. Modification of the usual structure of the equipment may be confined to accommodation of the red and blue light emitting means in an appropriate position and at a suitable spacing from the shelf or grill defining the target zone and incorporation of the control means and drives for the emitting means. Equipment of that kind can be, for example, a refrigerator or cooling shelf system, the latter widely employed in supermarkets for extending the shelf life of certain fruits and vegetables as well as combinations formed from different plant parts, such as salads. Equipment for other purposes include cooking equipment, display equipment and storage equipment, which may each be provided with the treatment apparatus for treating plant matter which, as the case may be, is to be cooked or is being displayed or stored. Cooking equipment, for example a microwave oven, may in fact be utilised as a convenient host for the treatment apparatus, i.e. to provide a suitable structure for accommodating the light emitting means, target zone and control means without necessarily being intended or even suitable for cooking the treated material; in that case, the equipment is furnished with an additional capability related to, but distinct from, its basic use. The mentioned display and storage equipment can take various forms, including supermarket and restaurant display and/or storage facilities for presenting produce and other plant materials at room temperature, and display and storage units for horticultural products in wholesale and retail outlets.

An embodiment of the present invention will now be more particularly described by way of example with reference to the accompanying drawings, in which:

FIG. 1 is in part a schematic longitudinal section and in part a block circuit diagram of treatment apparatus embodying the invention;

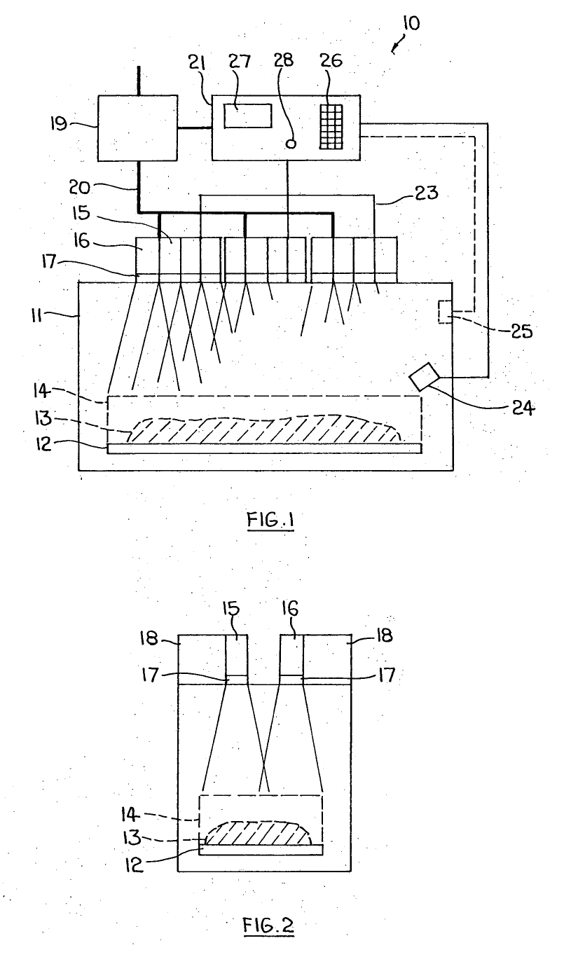

FIG. 2 is a schematic cross-section of the apparatus of claim 1, with omission of power and control circuitry;

FIG. 3 is a circuit diagram of the electrical interconnection of electrically operated light emitting means of the apparatus; and

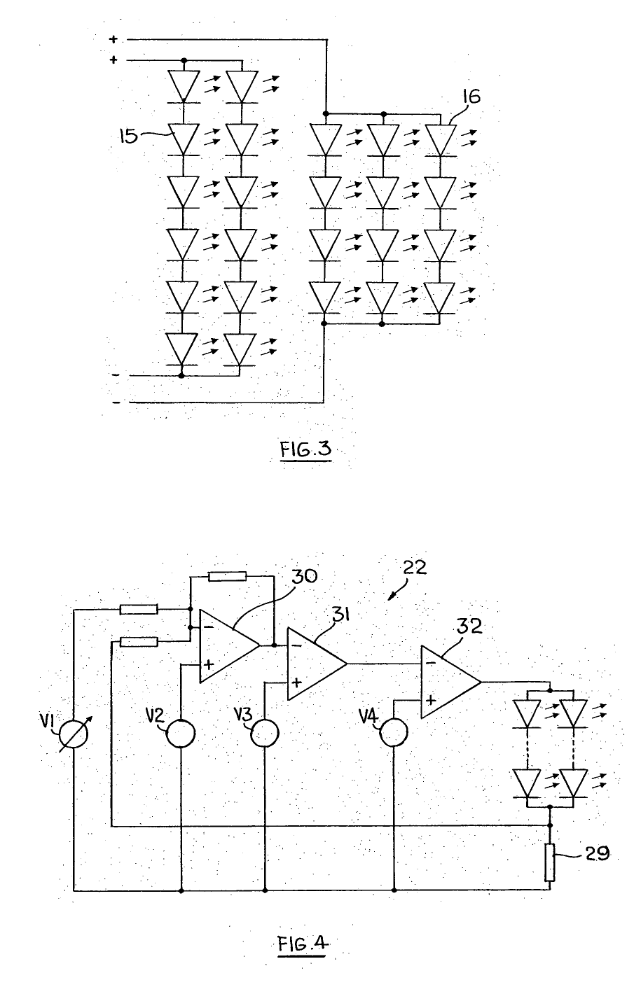

FIG. 4 is a circuit diagram of a variable current driver of part of light emitting means of FIG. 3.

Referring now to the drawings there is shown treatment apparatus 10 for treatment of plant matter by irradiation for a controlled total period of time with red and blue light of specific wavelengths selected from given respective ranges and at specific intensities similarly selected from given respective ranges. The object of the treatment is, for example, to stimulate reaction in the plant matter to produce a transient increase in phytochemicals having, inter alia, an antioxidation effect and/or to enhancing effect on nutritional value, flavour and other properties. Examples of methods achieving this object and other related objects are outlined in United Kingdom patent specifications 04 11 581.2, 06 01 602.6, 06 07 293.8 and 06 09 290.2. The described embodiment of the apparatus is in the form of a self-contained unit dedicated to this treatment, but the apparatus may equally well be integrated in equipment serving other purposes, such as those indicated in the introduction, and the embodiment is representative of the basic construction and operation of apparatus integrated in that way.

The treatment apparatus 10, as schematically shown in FIGS. 1 and 2 in longitudinal and transverse sections, comprises an enclosure 11 of generally box-shaped form with a side access opening (not depicted) optionally closed by a door of, for example, transparent material. In the case of apparatus integrated in larger equipment, the enclosure may be represented by, for example, the compartment walls of a refrigerating or cooking appliance or the boundary walls of a display or storage shelving system.

The enclosure 11 contains a shelf 12, which may be of solid material or consist of a grid or grill, for supporting plant matter 13 to be treated so that the plant matter is located in a target zone 14. The target zone is represented by an elongate three-dimensional space extending upwardly from the shelf. It could, in fact, be represented by a two-dimensional plane, but since the plant matter to be treated is necessarily three-dimensional the target zone should be regarded as a region accommodating most or all of the plant matter shapes and sizes intended to be treated.

Located at a spacing above the target zone 14 and, in particular, in the roof of the enclosure 11 (in the case of the self-contained unit of the embodiment) are red-light emitting means and blue-light emitting means respectively operable to emit red light with a wavelength of 625 to 660 nanometres at an intensity up to 500 microEinsteins and blue light with a wavelength of 440 to 470 nanometres at an intensity of up to 400 microEinsteins. The light emitting means consist of a plurality of red light-emitting diodes 15 and blue-light emitting diodes 16 each oriented to radiate light downwardly towards and into the target zone 14 by way of a respective beam collimating lens 17 shaping the light output of the associated diode into a cone. The use of lenses is optional and depends on the inherent capability or otherwise of the diodes to issue beams of suitable shape. The diodes 15 and 16 are disposed at such a spacing from the target zone and arranged at such proximity to one another, and the lenses 17 or the diodes provide output light in the form of beams of such conical shape, that the emitted red light and blue light combine into a substantially homogeneous blend in the target zone 14 so that the zone and the plant matter 13 when present in the zone are exposed to uniform irradiation with the light of both colours.

In order to achieve an arrangement of the diodes, of which in the present embodiment there are twelve each of the red light diodes 15 and blue light diodes 16, for the described purpose the diodes are ordered into two mutually parallel rows with the optical axes of the diodes and associated lens of one row parallel to or optionally at an inclination towards those of the other row. The red-light diodes 15 and blue-light diodes 16 are preferably arranged in alternation in each row. The spacings of the diodes from one another in each row and the spacings of the diodes of one row from those of the other row are selected to ensure, in conjunction with the optionally present lenses 17, merging of each cone of light of one colour at least partially with at least one cone of light of the other colour in the target zone 14.

The red-light diodes 15 and blue-light diodes 16 can be, in one example, ‘Lumiled’ LXHL-LD3C (Trade Mark) diodes and ‘Lumiled’ LXHL-LR3C (Trade Mark) diodes, respectively, each with a nominal 3 watts power output, the former having a forward voltage drop of 2.95 volts at 1.4 amps forward current and the latter a forward voltage drop of 3.90 volts at 1.0 amps of forward current. Each row of twelve diodes thus has a total power of 36 watts. In order to keep the voltage and current requirements of each row within the capabilities of diode drivers, as subsequently described, the diodes of each row are differently connected in series-parallel combinations as shown in FIG. 3. These connections lead to a total load of 17.7 volts at 2.8 amps for the red-light diodes 15 and 15.6 volts at 3.0 amps for the blue-light diodes 16. As shown in FIG. 2, a heat sink 18, such as a finned aluminium body, can be provided to dissipate the 72 watts of heat able to be discharged by the diodes.

The diodes 15 and 16 are supplied with operating power by way of a power supply unit 19 which, for example, transforms mains voltage to a direct voltage of 24 volts at a current up to 12 amps and supplies power to the diodes by way of a flexible power cable 20. Control of the diodes 15 and 16, in particular their periods of light emission and the brightness or intensities of their output light, is by way of a control unit 21 acting on a variable-current driver 22 (FIG. 4) for each diode colour group by way of flexible control bus cable 23. The control dependence on intensity is achieved on a feedback basis by way of an intensity sensor 24 located in the target zone 4 so as to be exposed to both the red and blue light and supplying a signal indicative of the intensity of the light of each colour in the target zone to the control unit. In addition, in the case of a cooled target zone 14, control of the period of emission and/or intensity can be undertaken by the control unit on the basis of a temperature-indicative signal from a temperature sensor 25 detecting the temperature in the enclosure 11 and thus in the target zone. The control unit 21 and sensors 24 and 25 are supplied with operating power from the power supply unit 19.

The control unit 21 comprises—in this embodiment with a manual control facility—user control elements 26, for example a keypad, for stopping and starting the irradiation and to allow input of information about desired periods of light emission and desired light intensity, although in simpler forms of commercial and domestic apparatus the actual input may in practice simply be indicative of type and other characteristics of the plant matter to be treated; the emission periods and intensities are then determined by the control unit 21 by correlation with stored data associating periods and intensities with specific plant types and characteristics. Determination of the intensities and/or emission periods is additionally carried out in conjunction with the output signal data of the intensity sensor 24. This form of sensor feedback allows compensation for variations in the performance of the diodes 15 and 16, which may be due to temperature change, manufacturing tolerances or ageing, as well as variations in spacing between the diodes and the plant matter 13, the height of which may vary, in the target zone 14. The control unit additionally includes a liquid crystal display 27 to display user information and a warning light 28 to indicate fault conditions, such as sensor signal failure or diode failure.

The construction of the control unit 21 is based on an integrated 8-bit microcontroller for issue of digital output commands, an EEPROM memory storing inter alia essential intensity data and associated emission periods and communicating with the microcontroller, an optional interface connectible with a computer for input of programming data, and a real-time clock which, in conjunction with the stored data, allows the microcontroller to switch the diodes on and off for emission period control and for varying their brightness over time. Components for providing regulated power feeds of 5 volts derived from the supplied 24 volts are also included.

The intensity sensor 24 is divided into two sensing components each associated with a respective transmission fitter providing maximum possible transmission of light of an individual one of the light wavelengths, i.e. that of the red-light diodes 15 or that of the blue-light diodes 16, while attenuating the light of the respective other wavelength. The sensing components are operable simultaneously to provide analog electrical output signals proportional to the incident light intensities of the respective wavelengths. Each output signal indicative of an actual intensity value is applied to an inverting input of a respective variable gain amplifier in the control unit 21 and a signal indicative of a target intensity value determined on the basis of the data stored in the unit is applied to a non-inverting input of the amplifier. The amplifier controls, in dependence on comparison of the input values, the variable-current drivers of the associated row of diodes 15 or 16 to set the brightness of the diodes in accordance with the intensity required in the target zone 16. A feedback capacitor can be coupled between the amplifier output and inverting input to enhance stability by reducing oscillations in light intensity due to the lag inherent in the feedback arrangement. The use of a variable gain amplifier allows compensation for change in the distance between the diodes 15 and 16 and the target zone 14, although this facility may be needed only in the case of treatment apparatus for specific purposes.

The temperature sensor 25 similarly provides an analog signal having a value representative of the instantaneous ambient temperature in the target zone 14. The signal can be applied to an input of a suitable comparator in the control unit 21 and a signal indicative of a temperature reference value applied to another input of the comparator. In the case of a difference between the compared values, for example due to user adjustment of a cooling temperature control, a signal output of the comparator can lead to shortening or extension of the emission periods of the red and blue light or to another appropriate influence on the irradiation of the plant matter 13.

Control of the red-light diodes 15 and blue-light diodes 16 by way of the control unit 21 is carried out, for each group of diodes of one colour, by the variable-current driver 22, as illustrated in FIG. 4, incorporated in a drive integrated circuit, which can include an 8-bit microcontroller (not shown) programmed to respond to digital commands from the control unit 21 and to provide smoothed control voltages for the diodes. Each variable-current driver is designed to drive the associated diodes 15 or 16 by regulation, on a feedback basis, of the current flowing through the diodes. For this purpose a resistor 29 samples the current flowing through the diodes to provide a feedback voltage which is applied via a further resistor to an input of an inverting amplifier 30 together with a control voltage V1 via a further resistor and a feedback, the voltage V1 deriving from the drive circuit microcontroller under the control of the control unit 21. A reference voltage V2 is applied to the other amplifier input to offset the amplifier output. This output is applied to an input of a fixed-gain inverting amplifier 31, which receives a further reference voltage V3 at its other input and which serves to remove the offset from and to invert the sense of the output of amplifier 30. The output of amplifier 31 is applied to an input of an error amplifier 32, which is part of a standard step-down regulator. A further reference voltage V4 is applied to the other input of the amplifier 32, the output of which drives the diodes via a power output stage (not shown). Such a driver makes it possible to vary the current through the associated diodes, and thus their intensity, linearly from zero to the maximum value with a variation of the control voltage V1.

The two sets of diodes 15 and 16 arranged in two rows with alternate colour disposition can be provided in the form of a module, containing either the twenty-four diodes of the described embodiment or a greater or lesser number. In further embodiments (not illustrated) such modules can be electrically connected serially and/or in parallel to construct a light array of variable dimensions appropriate to specific applications, for example cooled display shelving of variable size. The module connections can be detachable, such as by way of plug and socket couplings. Each module can contain, apart from the diodes, the associated optical system (if required) and diode drivers, and can be accommodated in a casing of stainless steel, polycarbonate or other material compatible with a food environment. As already indicated, the apparatus can be integrated in other equipment and in the case of more compact domestic appliances such as refrigerators, cookers and microwave ovens the mounting of the diodes may be dictated by the internal shape and configuration of the appliance. The control unit, sensors and drivers will also be adapted as required, especially simplified in the case of lower-cost equipment, and intensity control of the diodes may be superfluous in some contexts.

The operation of the treatment apparatus is evident from the foregoing description of its construction. Plant matter 13 placed on the shelf 12 is subjected to irradiation with a substantially homogeneous blend of red and blue light at intensities and for periods controlled by the control unit on the basis of user input and stored data which establish intensities and emission periods appropriate to the type of plant matter and/or the temperature in the target zone, in the latter instance with distinction between room temperature, cooling temperature and refrigerating temperature. Typical red and blue light wavelengths are 627 nanometres with a tolerance of +18 and −6.5 nanometres in the case of the red light and 455 nanometres with a tolerance of +5 and −15 nanometres in the case of the blue light. Typical red light intensities are 150 to 350 microEinsteins for a cooker environment, 20 to 30 microEinsteins for cooling shelving and 10 to 25 microEinsteins for a refrigerator. Typical blue-light intensities in corresponding applications are 100 to 200, 15 to 20 and 5 to 15 microEinsteins. Intensities may depend not only on the temperature, but also on the spacing between the diodes and target zone, which may vary between treatment apparatus of different construction and different equipment incorporating the apparatus.

The treatment apparatus described in the foregoing allows controlled irradiation of plant matter, such as produce, with specific forms of light from the visible spectrum, namely red light and blue light, having specific wavelengths and at specific intensities to enhance the nutritional value, storage life or other characteristics of the plant matter, in particular in such a way that irradiation is with a uniform mix of the two light colours and with the relationship of intensity to irradiation period controlled to ensure that the irradiation is sufficient to achieve the desired result without waste of energy or possible damage due to excessive intensities or irradiation periods.

1-57. (canceled)

58. A treatment apparatus comprising:
means defining a target zone in which a plant matter can be disposed,
red-light emitting means and blue-light emitting means for emitting red light and blue light, respectively, and directing the emitted light into the target zone for irradiation of plant matter when disposed therein, the emitting means being operable to provide a substantially homogenous blend of the emitted red and blue light in the target zone for at least a major part of the period of emission and to emit the red light and blue light at wavelengths of substantially 625 to 660 nanometres and substantially 440 to 470 nanometres respectively and at intensities in the target zone of up to substantially 500 microeinsteins and up to substantially 400 microeinsteins respectively, and
control means for controlling the emitting means to provide a predetermined relationship of the intensity of at least one of the emitted red light and emitted blue light to the period of emission of that light.

59. The apparatus as claimed in claim 58, wherein the control means is operable to cause the periods of red light emission and blue light emission to terminate substantially simultaneously.

60. The apparatus as claimed in claim 58, wherein the control means is operable to cause the periods of red light emission and blue light emission to terminate at predetermined or predeterminable different times.

61. The apparatus as claimed in claim 58, wherein the control means comprises timing means operable to terminate the period of emission of the emitted red light or blue light after a time predetermined or predeterminable in dependence on the intensity of that light.

62. The apparatus as claimed in claim 58, wherein the control means is operable to vary at least one of the period of emission of the emitted red or blue light and the intensity of the emitted red or blue light in dependence on, respectively the intensity of that light and the period of emission of that light.

63. The apparatus as claimed in claim 62, wherein the control means is operable to vary the intensity of the emitted red light or blue light by varying a drive power of the associated emitting means.

64. The apparatus as claimed in claim 62, comprising sensing means arranged to detect the intensity of the emitted red light or blue light in the target zone and to cause at least one of the intensity of that light and the period of emission of that light to be varied as a function of the detected intensity.

65. The apparatus as claimed in claim 64, wherein the sensing means comprises a respective sensor responsive to the wavelength of each of the emitted red light and the emitted blue light to detect the intensity of the light only of that wavelength and to supply a signal indicative of the detected intensity to the control means.

66. The apparatus as claimed in claim 58, wherein the control means is operable to control the periods of red light and blue light emission, the intensities of the emitted red and blue light or both the periods and the intensities in dependence on the temperature in the control zone or on predetermined characteristics of the matter to be treated.

67. The apparatus as claimed in claim 66, wherein the control means comprises temperature detecting means to detect the temperature in the target zone and to supply a signal indicative of the detected temperature to the control means.

68. The apparatus as claimed in claim 58, wherein the emitting means are operable to emit the red light and blue light discontinuously.

69. The apparatus as claimed in claim 58, wherein the emitting means are operable to emit the red light and blue light discontinuously at constant frequency.

70. The apparatus as claimed in claim 69, wherein the emitting means are operable to emit the red light and blue light discontinuously at non-constant frequency with equal durations of emission and equal durations of non-emission, the emission duration being different in length from the non-emission duration.

71. The apparatus as claimed in claim 58, wherein each of the red-light emitting means and blue-light emitting means comprises a plurality of discrete light sources.

72. The apparatus as claimed in claim 71, wherein each source is operable to emit light in a cone.

73. The apparatus as claimed in claim 72, wherein the sources are operable to emit light in cones in which each cone of emitted light of one colour runs into at least one cone of emitted light of the other colour in the target zone.

74. The apparatus as claimed in claim 71, wherein each emitting means comprises optical means for directing, shaping or directing and shaping the light emitted by the sources.

75. The apparatus as claimed in claim 71, wherein the sources of at least one of the emitting means are arranged in at least one row.

76. The apparatus as claimed in claim 75, wherein the red-light and the blue light sources are arranged in alternation in two manually parallel rows.

77. The apparatus as claimed in claim 76, wherein the two rows of sources define two relatively angled light output planes including an obtuse angle.

78. The apparatus as claimed in claim 71, wherein the sources are arranged in a plurality of groups each forming a respective module.

79. The apparatus as claimed in claim 58, comprising at least one of a heat sink to dissipate heat generated by the emitting means and an integrated power supply unit for power supply of the emitting means.

80. The apparatus as claimed in claim 58, comprising an enclosure enclosing the target zone.

81. The apparatus as claimed in claim 58, comprising cooling means for maintaining the target zone at a temperature of substantially 0 to 10° C.

82. The apparatus as claimed in claim 81, wherein the intensity of the red light in the target zone is 10 to 30 microeinsteins.

83. The apparatus as claimed in claim 81, wherein the intensity of the blue light in the target zone is 5 to 20 microeinsteins.

84. Cooling equipment provided with treatment apparatus as claimed in claim 58 for treating plant matter being cooled by the equipment.

85. The cooling equipment as claimed in claim 84, wherein the the equipment is one of a refrigerator and cooling shelf system.

86. The cooling equipment as claimed in claim 84, wherein the intensity of the red light in the target zone is 10 to 30 microeinsteins.

87. The cooling equipment as claimed in claim 84, wherein the intensity of the blue light in the target zone is 5 to 20 microeinsteins.

88. Display equipment provided with treatment apparatus as claimed in claim 58 for treating plant matter being displayed by the equipment.

89. Storage equipment provided with treatment apparatus as claimed in claim 58 for treating plant matter being stored by the equipment.
